(19) United States
(12) Patent Application Publication
(10) Pub. No.: US 2008/0247438 A1
(43) Pub. Date: Oct. 9, 2008

(54) Laterally pumped solid-state laser gain-module

(76) Inventors: Jihua Du, San Jose, CA (US); C. David Nabors, Sunnyvale, CA (US); Murray K. Reed, Menlo Park, CA (US)

Correspondence Address: STALLMAN & POLLOCK LLP, 353 SACRAMENTO STREET, SUITE 2200, SAN FRANCISCO, CA, 94111, US

(21) Appl. No.: 11/784,143

(22) Filed: Apr. 5, 2007

(51) Int. Cl. H01S 3/094

(52) U.S. Cl. 372/75

(57) ABSTRACT

A gain-module for a laser resonator has an elongated gain-element located in an diffusely reflective cylindrical enclosure having an elongated entrance slit for admitting pump radiation. Pump radiation is supplied by two diode-laser arrays assemblies each including a fast-axis collimating lens. Propagation axes of the diode-laser array assemblies are at an angle to each other. The propagation axes extend through the entrance slit into the enclosure without being intercepted by the gain-element and with the gain-element being located between the propagation-axes.

### TECHNICAL FIELD OF THE INVENTION

The present invention relates in general to laterally pumped solid-state lasers The invention relates in particular to a solid-state laser including a gain-element enclosed by a diffuse-reflector and wherein a length of the gain-element is laterally optically pumped by radiation from two or more diode-laser arrays.

### DISCUSSION OF BACKGROUND ART

Lateral pumping of a solid-state laser gain-element (gain-rod) using a radiation from a plurality of diode-laser arrays (diode-laser bars) rather than a single diode-laser bar has been proposed in several arrangements as a means of increasing pump power delivered to the rod and correspondingly increasing output power in a beam delivered by the solid-state laser. In any such arrangement beam quality obtainable from the solid-state laser is dependent, inter alia, on the cross-section uniformity of absorption of the radiation from the diode-laser bars.

One approach to achieving acceptable uniformity of absorption has been to provide a solid-state laser having a laser enclosure including a solid-state gain-module wherein 3 or more diode-laser bars are arranged in rotational symmetry around a gain-rod. The gain-rod provides a gain element of a solid-state laser resonator aligned about the gain-rod. The rotational symmetry of the diode-laser bars can be effective in improving symmetry of absorption of pump (diode-laser) radiation provided that there are at least three diode-laser bars. One such arrangement is described in U.S. Pat. No. 6,650,668 assigned to the assignee of the present invention. The plurality of diode-laser bars in the above discussed arrangements also allowed greater pump-power to be delivered to the gain-rod than could be delivered by a single diode-laser bar. This approach, however, has a disadvantage that it is not possible to access all the linear arrays from one side of the gain-module. Accordingly, if it becomes necessary to determine if a diode-laser bar has failed, the gain-module must be removed from the laser enclosure. This usually results in the laser resonator having to be realigned when the gain-module is returned to the enclosure.

In a solid-state laser it is not considered prudent to pump the gain-rod above a linear power-density that might cause fracturing or breaking the gain rod. By way of example pumping limits for YLF and YAG rod materials may be about 40 Watts per cm (W/cm) and 150 W/cm respectively. In earlier solid-state lasers, four or more diode-laser bars were necessary to provide this absorbed power level. As diode-laser technology has progressed, these power levels can be obtained from as few as two diode-laser bars of comparable cost. However, pumping with only two diode-laser bars in the above discussed rotationally symmetric pumping arrangements can result in less than acceptable uniformity of absorption of pump-radiation.

One approach to providing uniformity of absorption of diode-laser radiation from one or two diode-laser bars in a gain-rod is to provide an arrangement in which the gain-rod is surrounded by reflector and the diode-laser radiation is directed into the reflector from outside of the reflector. Several such arrangements have described in the prior-art. By way of example, U.S. Pat. No. 6,608,852 discloses a gain-module wherein the gain-rod is enclosed by a diffuse reflector. Two diode-laser bar assemblies, arranged one above the other, direct pump radiation into the reflector through an opening therein wide enough to admit divergent beams from the two diode-laser bars. Including such a wide opening in the reflector allows diffusely reflected pump radiation to leak out of the reflective enclosure through the opening. This limits the efficiency of pumping regardless of how effective the diffuse reflector arrangement is in providing uniformity of absorption of the pump-radiation in the gain-rod. There is a continuing need for a diode-laser lateral pumping arrangement for a gain-rod that provides not only uniformity of absorption of pump-radiation in a gain-rod, but also provides that the radiation is efficiently absorbed in the gain-rod.

### SUMMARY OF THE INVENTION

The present invention is directed to a gain-module for a laser resonator. In one aspect a gain-module in accordance with the present invention comprises an elongated gain-element located in an enclosure having a diffusely reflective wall. The reflective wall has an elongated opening therein. The gain module includes first and second diode-laser arrays each thereof having a fast-axis and a slow-axis perpendicular to each other and a propagation-axis perpendicular to the fast- and slow-axes. First and second cylindrical lenses are arranged to form radiation emitted by respectively the first and second diode-laser arrays into respectively first and second substantially collimated beams propagating respectively generally along the propagation-axes of the first and second diode-laser arrays. The diode-laser arrays are arranged, with respect to each other and with respect to the enclosure, such that the propagation axes thereof are at an angle to each other and extend through the opening in the wall of the enclosure, into the enclosure, without being intercepted by the gain element.

In a preferred embodiment of the inventive gain-module the diffusely reflective enclosure wall is cylindrical. The gain-element is in the form of a rod having a circular cross-section and is located concentrically within a transparent cylindrical tube with the gain-element and the tube located eccentrically with respect to the enclosure wall. The longitudinal-axes of the diode-laser arrays and the substantially collimated beams propagating therealong intersect about in the opening in the wall of the enclosure.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a lateral cross-section view schematically illustrating a preferred embodiment of a solid-state laser gain-module in accordance with the present invention including a gain-rod located in an enclosure having a diffusely reflective cylindrical wall with an elongated aperture therein and two laser diode-arrays each thereof having a fast axis lens associated therewith for providing a roughly collimated beam of radiation emitted by the diode-laser array, the gain-rod being concentrically arranged within the cylindrical wall and the diode-laser arrays and lenses associated therewith being arranged such that propagation axes of the roughly collimated beams are at an angle to each other, intersect in the aperture of the cylindrical wall, and extend into the enclosure without being intercepted by the rod.

FIG. 2 is a plan view from above schematically illustrating the gain-module of FIG. 1 further including third and fourth diode-laser arrays arranged in the manner of the first and second diode-laser arrays of FIG. 1.

FIG. 3 is a cross-section view schematically illustrating another preferred embodiment of a solid-state laser gain-module in accordance with the present invention, arranged within the diffusely reflective cylindrical wall of the enclosure.

FIG. 4 is a contour graph schematically illustrating computed cross-section absorption of diode-laser radiation in the gain-module of FIG. 3.

### DETAILED DESCRIPTION OF THE INVENTION

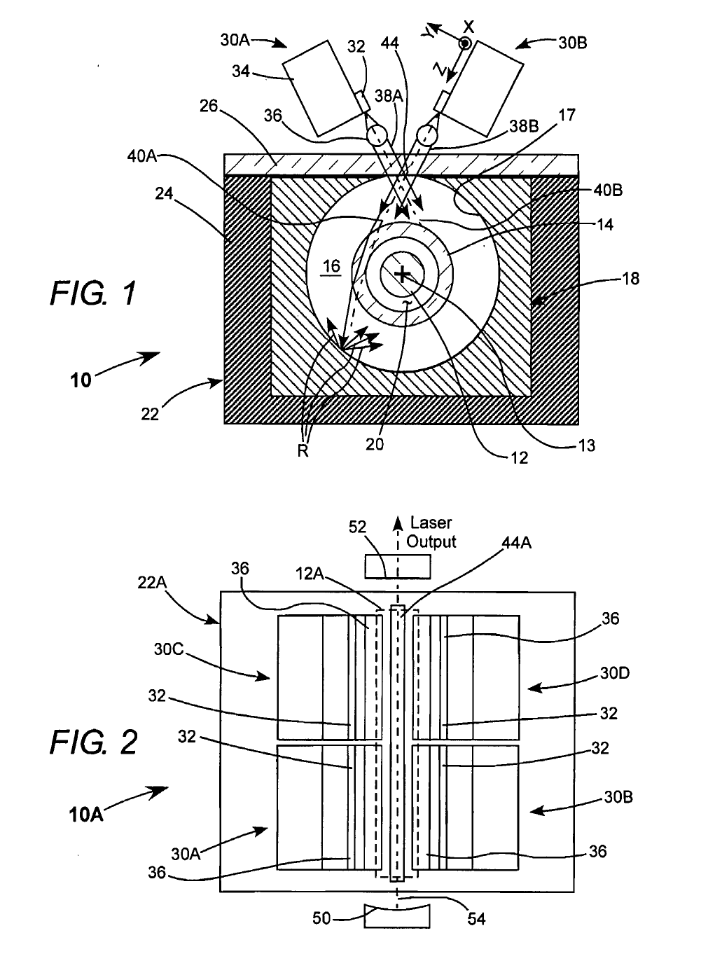

Referring now to the drawings, wherein like components are designated by like reference numerals, FIG. 1 is a lateral cross-section view schematically illustrating a preferred embodiment 10 of a solid-state laser gain module in accordance with the present invention. Laser 10 includes an elongated gain-element 12 here being in the form of a rod having a circular cross-section. Gain-rod 12 is located within a tube 14 of a material that is minimally absorbing for the wavelength of radiation that will be used to energize the gain rod, for example, glass or fused silica. Preferably gain-rod 12 is concentrically located in tube 14. The diameter of tube 14 is selected according to the diameter of rod 12 such that there is a space 20 between the rod and the tube. Gain-rod 12 and tube 14 are located in a cylindrical chamber or enclosure 16 formed in a block 18 of a material selected such that wall 17 of the enclosure is diffusely reflective. One suitable material for the enclosure block is Spectralon® available from Labsphere Inc. of North Sutton, N.H. A finely machined surface of this material can have a diffuse reflectivity as high as about 99%.

Block 18 is tightly surrounded by a housing 22 including a metal channel 24 to which is sealed by a window 26 of a transparent material such as glass or fused silica. End plates (not shown) for the housing include facilities to flow water through enclosure 16 and windows to permit optical access for a laser resonator including gain-rod 12. Preferably, water flows first, quickly, through tube 14 for cooling rod 12, and then flows slowly through the space in the enclosure between tube 14 and wall 17 of the enclosure to cool the enclosure block 18. Concentrically locating gain-rod 12 in tube 14 facilitates uniform cooling of the rod. This water-cooling arrangement should not be considered as limiting the present invention. Water-cooling arrangements for solid state lasers are well known in the art to which the present invention pertains and a detailed description of any such arrangement is not necessary for understanding principles of the present invention. Accordingly, such a detailed description is not presented herein.

Optical pump radiation is provided by two diode-laser bar assemblies 30, designated in FIG. 1 as assemblies 30A and 30B. Each assembly includes a diode-laser bar (linear array of diode-laser emitters) 32 in thermal communication with a heat sink 34. Output of the diode-laser emitters in each bar is substantially collimated in the fast-axis (designated in FIG. 1 as the Y-axis) of the diode-laser bar and emitters thereof by a cylindrical lens 36. The term “substantially collimated” as used herein recognizes that because of optical aberrations introduced by the cylindrical lens and the quality of the diode-laser beam incident on the lens the light can not be assumed to be exactly collimated.

Substantially collimated beams 38A and 38B from respectively assemblies 30A and 30B propagating along axes 40A and 40B intersect in an elongated opening 44 in diffusely reflective enclosure 16. The opening preferably has a width just sufficient to admit the intersecting beams. Longitudinal axis 13 of gain rod 12 is preferably aligned with elongated opening 44. The Z-axes of diode-laser bar assemblies 30A and 30B are inclined to each other and the diode-laser bar assemblies are positioned with respect to opening 44 such that propagation axes 40A and 40B extend into the enclosure and are incident on wall 17 of enclosure 16, passing gain-rod 12 on opposite sides thereof without being intercepted by the gain-rod. Any ray from any one of the beams 38A and 38B that is incident on wall 17 of the enclosure is diffusely reflected from the wall as indicated in FIG. 1 by arrows R, the beams are thus caused to break up with radiation from the beams undergoing multiple diffuse reflections from wall 17 of the enclosure 16.

Any radiation incident on wall 17 that is not reflected by the wall is eventually absorbed in the material of block 18. Any reflected radiation that reaches opening 44 will be lost through the opening, which is why it is preferable to keep the size of the opening only just sufficient to admit the intersecting beams 38A and 38B. As the wavelength of the pump radiation can be selected such that absorption thereof in the cooling water is negligible compared with absorption in wall 17, and as the material of tube 14 can be selected such that absorption therein is correspondingly negligible, essentially all radiation not absorbed in wall 17 or lost through opening 44 is eventually absorbed in gain-rod 12. The positioning of the gain-rod 12 in enclosure 16 and the angle between the Z-axes of diode-laser assemblies can be selected such that absorption of pump-radiation in the gain-rod is substantially uniform. Dimensions of one suitable configuration are discussed further hereinbelow.

As noted above, the diode laser bar assemblies are positioned so that the propagation axes 40A and 40B are arranged to bypass the gain rod. It should be appreciated that because of the diverging properties of the light, scattering effects, etc. some of the pump light may reach the gain rod directly. Such an arrangement is within the scope of the subject invention. It is the intent, however, that a majority and preferably a large majority of the pump light initially bypass the rod and strike the wall 17 in the first instance in order to maximize the geometric uniformity of the pumping.

FIG. 2 is a plan view from above schematically illustrating one preferred longitudinal arrangement 10A of a solid-state laser gain module in accordance with the present invention. Module 10A is arranged in cross-section as depicted in FIG. 1 but includes a second pair of diode-laser bar assemblies 30C and 30D arranged in the same manner as assemblies 30A and 30B. Assemblies 30A and 30C are aligned in the slow-axis (X-axis) direction thereof and assemblies 30B and 30D are also aligned in the slow-axis (X-axis) direction thereof. The housing, designated as housing 22A in FIG. 2 is configured to accommodate the additional pair of diode-laser bar assemblies. The gain-rod, designated as gain-rod 12A and illustrated in phantom in FIG. 2, extends sufficiently past the ends of the diode-laser assembly to accommodate the slow-axis beam divergence of end-ones of the emitters in the diode-laser bars. Opening 44A in the enclosure is long enough to accommodate the output of both pairs of diode-laser bar assemblies. A laser resonator including gain-rod 12A and having a longitudinal axis 54 is formed between reflectors 50 and 52. Reflector 52 is partially transmissive and serves as an outcoupling mirror of the laser resonator.

Those skilled in the art will recognize that module 10A is only one of many possible arrangements of a gain-module in accordance with the present invention, however, any module must have at lest one pair of diode-laser bar assemblies arranged generally as depicted in FIG. 1. Other laser arrangements are possible in which the inventive gain modules are longitudinally (slow-axis) aligned, with each module having at least one-pair of diode-laser bar assemblies 30 arranged generally as depicted in FIG. 1.

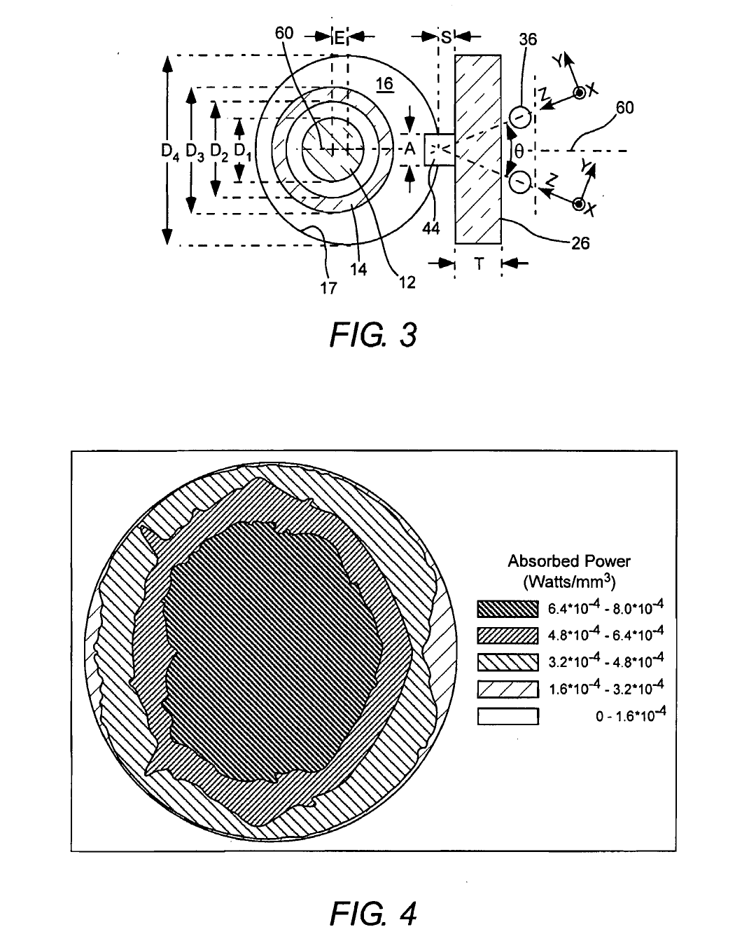

FIG. 3 schematically illustrates a preferred configuration of a gain-module in accordance with the present invention arranged for maximizing the uniformity of absorption in gain rod 12. Gain-rod 12 is assumed to be a Nd:YAG gain rod with 0.7% doping and is assumed to have a diameter D₁ of 4 mm. Tube 14 is assumed to be made from fused silica and is assumed to have an inside diameter D₂ of 6 mm and an outside diameter D₃ of 8 mm. Wall 17 of enclosure 16 is assumed to have a diffuse reflectivity of 99% material with a Lambertian distribution. Enclosure 16 is assumed to have a diameter D₄ of 12 mm. Opening 44 in the enclosure is assumed to have a width A of 2 mm. Window 26 is assumed to made of fused silica, have a thickness T of 3 mm, and be spaced by a distance S of 0.2 mm from opening 44.

Gain-rod 12 is assumed to be concentrically disposed in with the common center of the tube 14 and eccentrically located in enclosure 16 and displaced by a distance E of 1 mm from the center of the enclosure. The common center of the rod and the tube and the center of the enclosure are assumed to be aligned in a plane 60 parallel to the X-axes of the diode laser bars. There is assumed to be an angle θ of 45° between the propagation-axes (Z-axes) of the diode-laser bars. Plane 60 is assumed to bisect angle θ. The emitter position of the diode-laser bars is designated by dashed line 61. A computed pump-energy absorption profile in gain-rod 12 is depicted in contour-graph form in FIG. 4. The orientation of the graph corresponds to the orientation of the apparatus of FIG. 3. Computations indicate that about 69% of pump light input power is absorbed in the gain-rod. It is believed that at least half of the 31% of pump that is not absorbed is lost by absorption in wall 17 of enclosure 16 as a result of multiple reflections therefrom.

The present invention is described above in terms of a preferred and other embodiments. The invention is not limited, however, to the embodiments described and depicted. Rather, the invention is limited only by the claims appended hereto.

What is claimed is:

1. A gain-module for a laser resonator, comprising:
an elongated gain-element located in an enclosure having a diffusely reflective wall, the reflective wall having an elongated opening therein;
first and second diode-laser arrays each thereof having a fast-axis and a slow-axis perpendicular to each other and a propagation-axis perpendicular to the fast- and slow-axes;
first and second cylindrical lenses arranged to form radiation emitted by respectively said first and second diode-laser arrays into respectively first and second beams said beams being substantially collimated and propagating generally along the propagation-axes of said diode-laser arrays; and
wherein said diode-laser arrays are arranged with respect to each other and with respect to said enclosure such that said propagation-axes thereof are at an angle to each other and extend through said opening in the wall of said enclosure into said enclosure without being intercepted by said gain-element and with said gain-element being located between said propagation-axes.

2. The gain-module of claim 1, wherein said propagation-axes of said diode-laser arrays and said substantially collimated beams propagating therealong intersect about in the opening in the wall of said enclosure.

3. The gain-module of claim 1, wherein said enclosure is cylindrical.

4. The gain-module of claim 1, wherein said enclosure has a circular cross section.

5. The gain-module of claim 4, wherein said gain-element is eccentrically located in said enclosure.

6. The gain-module of claim 5, wherein said gain-element is located on an alignment plane bisecting said angle between the propagation-axes of said diode-laser arrays.

7. The gain-module of claim 5, wherein said the center of said gain-element is located further from the said opening in the wall of said enclosure than the center of said enclosure.

8. The gain-module of claim 1, wherein said gain-element is surrounded by a tube located within said enclosure and transparent to the radiation emitted by said diode-laser arrays.

9. The gain-module of claim 8, wherein said gain-element is concentrically located in said transparent tube.

10. A gain-module for a laser resonator, comprising:
a cylindrical enclosure having a diffusely reflective wall, the reflective wall having an elongated opening therein;
a gain-rod, said gain-rod having a circular cross-section and a longitudinal axis, and said gain-rod being located in said enclosure with said longitudinal-axis thereof aligned with said elongated opening in said enclosure;
first and second diode-laser arrays each thereof having a fast-axis and a slow-axis perpendicular to each other and a propagation-axis perpendicular to the fast- and slow-axes;
first and second cylindrical lenses arranged to form radiation emitted by respectively said first and second diode-laser arrays into respectively first and second beams said beams being substantially collimated and propagating generally along the propagation-axes of said diode-laser arrays; and
wherein said diode-laser arrays are arranged with respect to each other and with respect to said enclosure such that said propagation-axes thereof are at an angle to each other and extend through said opening in the wall of said enclosure into said enclosure without being intercepted by said gain-rod, with said gain rod being located between said propagation-axes and with the center of said gain rod being located about on an alignment axis bisecting the angle between said propagation axes of said diode-laser arrays.

11. The gain-module of claim 10, wherein said enclosure has a circular cross section.

12. The gain-module of claim 11, wherein said gain-element is eccentrically located in said enclosure.

13. The gain-module of claim 12, wherein said gain-element is located on an alignment plane bisecting said angle between the propagation-axes of said diode-laser arrays.

14. The gain-module of claim 13, wherein said the center of said gain-element is located further from the said opening in the wall of said enclosure than the center of said enclosure.

15. A gain laser module comprising:
an enclosure having a cylindrical diffusively reflecting inner surface, said enclosure having an elongated opening extending along the axis of the cylinder;
an elongated laser rod located within the enclosure; and
a pair of diode laser arrays each emitting pump light along a propagation axis, with the arrays being positioned so that pump light enters the enclosure through the opening and such that the propagations axes thereof intersect each other and bypass the rod and intersect with the inner surface of the enclosure so that pump light is diffusively reflected and absorbed in the laser rod.

16. A gain module as recited in claim 15, wherein said rod is eccentrically located within said enclosure.

17. A gain module as recited in claim 15, further include a pair of cylindrical lenses arranged to collimate the pump light emitted from the diode arrays in a fast axis thereof.
